(19) United States
(12) Patent Application Publication
(10) Pub. No.: US 2022/0036270 A1
(43) Pub. Date: Feb. 3, 2022

(54) GRAPH-BASED HANDLING OF SERVICE REQUESTS

(71) Applicant: Raytheon BBN Technologies Corp., Cambridge, MA (US)

(72) Inventors: Brett Benyo, Ayer, MA (US); Fusun Yaman-Sirin, Arlington, MA (US)

(21) Appl. No.: 17/166,574

(22) Filed: Feb. 3, 2021

Related U.S. Application Data
(60) Provisional application No. 63/004,840, filed on Apr. 3, 2020.

(51) Int. Cl. G06Q 10/06; G06F 9/50

(52) U.S. Cl. CPC G06Q 10/06315; G06F 9/5038; G06Q 10/06375

(57) ABSTRACT

Techniques for graph-based handling of service requests are disclosed. The techniques include: receiving a service request that requires at least one resource from multiple available resources; computing a graph-based opportunity cost metric associated with satisfying the service request; and handling the service request based at least on the graph-based opportunity cost metric.

### RELATED APPLICATIONS

This application claims priority under 35 USC § 119(e) to U.S. Provisional Patent Application Ser. No. 63/004,840, titled “GRAPH-BASED HANDLING OF SERVICE REQUESTS,” filed Apr. 3, 2020, which is hereby incorporated by reference in its entirety. rights in this invention.

### STATEMENT REGARDING FEDERALLY-SPONSORED RESEARCH OR DEVELOPMENT

This application was made with government support under Contract No. FA8750-19-C-0056 awarded by the Air Force Research Laboratory (AFRL). The U.S. Government has certain rights in this invention.

### BACKGROUND

In general, services operate using a finite set of available resources. Such services may include, for example: supply chain management (limited storage, transportation infrastructure, etc.); cloud-based software solutions (limited hardware, software licenses, processor cycles, network bandwidth, etc.); ride sharing (limited vehicles, drivers, road capacity, gasoline, etc.); medical services (limited medical personnel, supplies, hospital beds, etc.); project management (limited employees, business equipment, vendor availability, etc.); military operations (limited personnel, vehicles, munitions, etc.); and/or any other kind of service that operates using a finite set of available resources. Time may also be considered a limited resource for many kinds of services. In addition, available resources and/or demand for the service(s) may change over time.

Satisfying a particular service request may affect the service provider's future reserve capacity (i.e., resources available to satisfy future service requests). Failure to properly predict the future effects of satisfying a service request may result in sub-optimal conditions, where the service provider is unable to properly satisfy future requests. Typical approaches use rule-based systems, relying on assumptions and heuristics, to attempt to determine when to utilize scarce or limited resources. Such approaches can be difficult to maintain and may result in scarce or limited resources being underutilized. For example, scarce or limited resource may be held in reserve for an anticipated future service request that never arrives. Underutilization of resources may have financial and/or human costs, depending on the kind of service being offered.

Approaches described in this section have not necessarily been conceived and/or pursued prior to the filing of this application. Accordingly, unless otherwise indicated, approaches described in this section should not be construed as prior art.

### TECHNICAL FIELD

The present disclosure relates generally to handling service requests and managing limited resources available to handle service requests.

### SUMMARY

In general, one or more embodiments use graph-based techniques to evaluate the effects of satisfying service requests. For example, a graph-based algorithm may be used to compute the expected reduction in future capacity if limited resources are used to satisfy a current service request. In a graph-based algorithm (e.g., based on a bipartite graph), the density and connectivity of the graph may indicate the service provider's resource capacity for handling future service requests. The service provider may use a resulting opportunity cost metric to determine how to handle the current service request (e.g., whether to satisfy the request, decline to satisfy the request, delegate the service request to another service provider, choose among two or more options for satisfying the request, etc.). In some cases, the opportunity cost metric may indicate that the service provider should hold resources in reserve to satisfy a potential future service request. The determination may include evaluating the reduction in available resource capacity in relation to the estimated resource need. The reduction may be compared with the benefit that satisfying the service request would provide with respect to one or more of the service provider's top-level goals (e.g., financial goals, quality of service guarantees, business priorities, etc.). Computing the effect of satisfying the current service request on the service provider's current and future resource capacity may allow the service provider to use scarce resources more optimally. For example, the service provider may determine that the anticipated loss in resource capacity would be adequately and/or better covered by accessing alternative resources.

In general, in one aspect, one or more non-transitory computer-readable media store instructions that, when executed by one or more processors, cause the one or more processors to perform operations including: receiving a service request that requires at least one resource from multiple available resources; computing a first graph-based opportunity cost metric associated with satisfying the service request; and handling the service request based at least on the first graph-based opportunity cost metric.

The operations may further include: computing a second graph-based opportunity cost metric associated with satisfying the service request, where the first graph-based opportunity cost metric is based on a first resource allocation from among the available resources, where the second graph-based opportunity cost metric is based on a second resource allocation from among the available resources, and where handling the service request includes satisfying the service request using one of the first resource allocation or the second resource allocation.

The operations may further include receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request, where the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the plurality of available resources and a second set of nodes corresponding to current service requests and predicted future service requests, and the weights of the edges may be based, at least in part, on one or more of service request priorities and resource affinities for satisfying service requests.

In general, in one aspect, a system includes at least one device including a hardware processor, the system being configured to perform operations including: receiving a service request that requires at least one resource from multiple available resources; computing a first graph-based opportunity cost metric associated with satisfying the service request; and handling the service request based at least on the first graph-based opportunity cost metric.

The operations may further include: computing a second graph-based opportunity cost metric associated with satisfying the service request, where the first graph-based opportunity cost metric is based on a first resource allocation from among the available resources, where the second graph-based opportunity cost metric is based on a second resource allocation from among the available resources, and where handling the service request includes satisfying the service request using one of the first resource allocation or the second resource allocation.

The operations may further include receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request, where the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the plurality of available resources and a second set of nodes corresponding to current service requests and predicted future service requests, and the weights of the edges may be based, at least in part, on one or more of service request priorities and resource affinities for satisfying service requests.

In general, in one aspect, a method includes: receiving a service request that requires at least one resource from multiple available resources; computing a first graph-based opportunity cost metric associated with satisfying the service request; and handling the service request based at least on the first graph-based opportunity cost metric.

The method may further include: computing a second graph-based opportunity cost metric associated with satisfying the service request, where the first graph-based opportunity cost metric is based on a first resource allocation from among the available resources, where the second graph-based opportunity cost metric is based on a second resource allocation from among the available resources, and where handling the service request includes satisfying the service request using one of the first resource allocation or the second resource allocation.

The method may further include receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request, where the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the plurality of available resources and a second set of nodes corresponding to current service requests and predicted future service requests, and the weights of the edges may be based, at least in part, on one or more of service request priorities and resource affinities for satisfying service requests.

In general, in one aspect, one or more non-transitory computer-readable media store instructions that, when executed by one or more processors, cause: receiving a service request that requires at least one resource from available resources; computing a first graph-based opportunity cost metric associated with satisfying the service request; and handling the service request based at least on the first graph-based opportunity cost metric.

The one or more non-transitory computer-readable media may further store instructions that, when executed by one or more processors, cause: computing a second graph-based opportunity cost metric associated with satisfying the service request, wherein the first graph-based opportunity cost metric is based on a first resource allocation from among the available resources, wherein the second graph-based opportunity cost metric is based on a second resource allocation from among the available resources, and wherein handling the service request comprises satisfying the service request using one of the first resource allocation or the second resource allocation.

The one or more non-transitory computer-readable media may further store instructions that, when executed by one or more processors, cause: receiving user input indicating a selection of either the first resource allocation or the second resource allocation for satisfying the service request.

The one or more non-transitory computer-readable media may further store instructions that, when executed by one or more processors, cause: receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request. The first graph-based opportunity cost metric may be based, at least in part, on a difference between a first sum of edge weights in the first graph and a second sum of edge weights in the second graph. The first graph-based opportunity cost metric may be based, at least in part, on an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the available resources and a second set of nodes corresponding to service requests. The second set of nodes may include nodes corresponding to current service requests and nodes corresponding to predicted future service requests. The weights of the edges may be based, at least in part, on one or more of service request priorities and resource affinities for satisfying service requests.

In general, in one aspect, a system includes at least one device including a hardware processor, the system being configured to perform operations including: receiving a service request that requires at least one resource from available resources; computing a first graph-based opportunity cost metric associated with satisfying the service request; and handling the service request based at least on the first graph-based opportunity cost metric.

The operations may further include: computing a second graph-based opportunity cost metric associated with satisfying the service request, wherein the first graph-based opportunity cost metric is based on a first resource allocation from among the available resources, wherein the second graph-based opportunity cost metric is based on a second resource allocation from among the available resources, and wherein handling the service request comprises satisfying the service request using one of the first resource allocation or the second resource allocation.

The operations may further include: receiving user input indicating a selection of either the first resource allocation or the second resource allocation for satisfying the service request.

The operations may further include: receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request. The first graph-based opportunity cost metric may be based, at least in part, on a difference between a first sum of edge weights in the first graph and a second sum of edge weights in the second graph. The first graph-based opportunity cost metric may be based, at least in part, on an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the available resources and a second set of nodes corresponding to service requests. The second set of nodes may include nodes corresponding to current service requests and nodes corresponding to predicted future service requests. The weights of the edges may be based, at least in part, on one or more of service request priorities and resource affinities for satisfying service requests.

In general, in one aspect, a method includes: receiving a service request that requires at least one resource from available resources; computing a first graph-based opportunity cost metric associated with satisfying the service request; and handling the service request based at least on the first graph-based opportunity cost metric.

The method may further include: computing a second graph-based opportunity cost metric associated with satisfying the service request, wherein the first graph-based opportunity cost metric is based on a first resource allocation from among the available resources, wherein the second graph-based opportunity cost metric is based on a second resource allocation from among the available resources, and wherein handling the service request comprises satisfying the service request using one of the first resource allocation or the second resource allocation.

The method may further include: receiving user input indicating a selection of either the first resource allocation or the second resource allocation for satisfying the service request.

The method may further include: receiving user input indicating one or more weights assigned to one or more factors contributing to computation of the first graph-based opportunity cost metric.

Computing the first graph-based opportunity cost metric associated with satisfying the service request may include: comparing a first graph corresponding to a current state of available resources before satisfying the service request with a second graph corresponding to a projected state of available resources after satisfying the service request. The first graph-based opportunity cost metric may be based, at least in part, on a difference between a first sum of edge weights in the first graph and a second sum of edge weights in the second graph. The first graph-based opportunity cost metric may be based, at least in part, on an inverse exponential function applied to a first incoming edge count in the first graph and a second incoming edge count in the second graph. The second graph may include one or more resources predicted to become available in a time interval needed to satisfy the service request.

Computing the first graph-based opportunity cost metric associated with satisfying the service request may include: computing a plurality of opportunity cost values over time; and computing an area under a curve of the plurality of opportunity cost values.

The first graph-based opportunity cost metric may be based at least on weights of edges between a first set of nodes corresponding to the available resources and a second set of nodes corresponding to service requests. The second set of nodes may include nodes corresponding to current service requests and nodes corresponding to predicted future service requests. The weights of the edges may be based, at least in part, on one or more of service request priorities and resource affinities for satisfying service requests.

One or more embodiments described in this Specification and/or recited in the claims may not be included in this General Overview section.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 is a block diagram of an example of a system according to an embodiment;

FIG. 2 is a block diagram of an example of graph-based service request handling according to an embodiment;

FIG. 3 illustrates an example of a chart according to an embodiment;

FIG. 4 is a flow diagram of an example of operations for graph-based handling of service requests according to an embodiment; and

FIG. 5 is a block diagram of an example of a computer system according to an embodiment.

### DETAILED DESCRIPTION

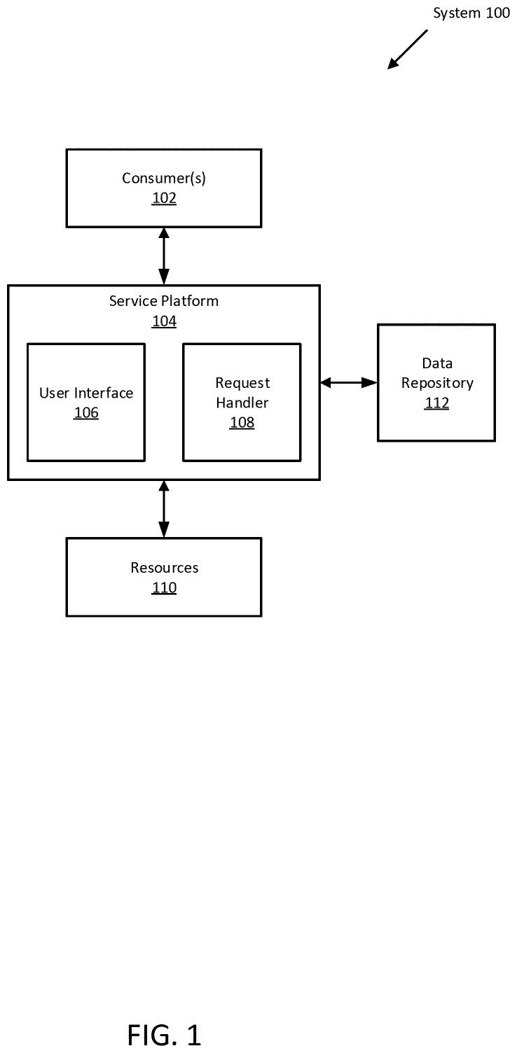

FIG. 1 is a block diagram of an example of a system 100 according to an embodiment. In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, a service platform 104 refers to hardware and/or software configured to perform operations described herein for graph-based service request handling. Specifically, the service platform 104 may include a request handler 108 configured to receive service requests from one or more consumers 102 and handle the allocation of resources 110 to satisfying one or more of the requests. In some cases, the request handler 108 may determine that one or more of the resources 110 should be held in reserve, for a future service request, rather than being allocated to a current service request. Some examples of operations for graph-based service request handling are described in further detail below.

In an embodiment, a user interface 106 refers to hardware and/or software configured to facilitate communications between a user and the service platform 104. For example, a user may access the user interface 106 to configure parameters of the request handler 108 (e.g., weights to apply to factors used to compute opportunity cost metrics, as described below) and/or view data (e.g., opportunity cost metrics) generated by the request handler 108. A user interface 106 renders user interface elements and receives input via user interface elements. A user interface 106 may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms.

In an embodiment, different components of a user interface 106 are specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface 106 may be specified in one or more other languages, such as Java, Python, Perl, C, C++, and/or any other language or combination thereof.

In an embodiment, the service platform 104 is configured to store data in a data repository 112. A data repository 112 is any type of storage unit and/or device (e.g., a file system, database, collection of tables, or any other storage mechanism) for storing data. A data repository 112 may include multiple different storage units and/or devices. The multiple different storage units and/or devices may or may not be of the same type or located at the same physical site. Further, a data repository 112 may be implemented or may execute on the same computing system as one or more other components of the system 100. Alternatively or additionally, a data repository 112 may be implemented or executed on a computing system separate from one or more other components of the system 100. A data repository 112 may be logically integrated with one or more other components of the system 100. Alternatively or additionally, a data repository 112 may be communicatively coupled to one or more other components of the system 100 via a direct connection or via a network.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

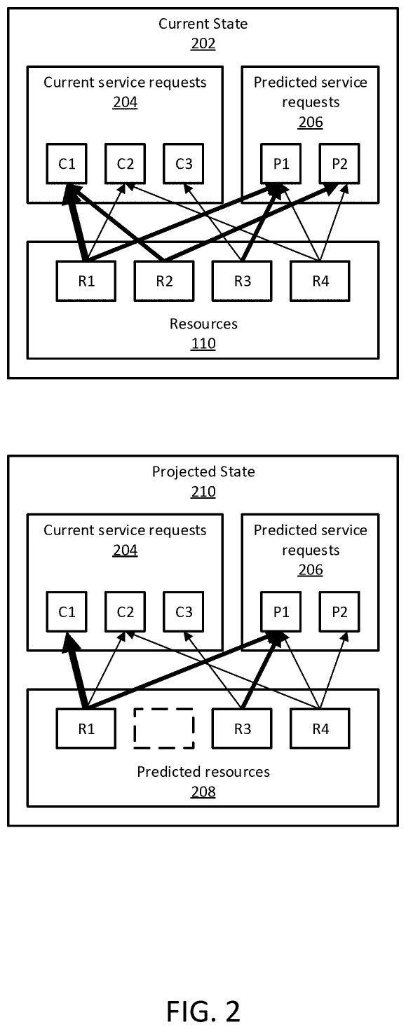

In an embodiment, a request handler 108 is configured to determine whether one or more of the resources 110 under its control should be reserved to satisfy a future service request. The request handler 108 may be configured to make this determination by evaluating the reduction in available resource capacity in relation to the estimated resource need. The request handler 108 may compare that evaluation to the benefit that satisfying the service request would provide, for example, in support of a top-level goal of the service platform 104. The request handler 108 may compute one or more opportunity cost metrics using a graph algorithm. For example, the request handler 108 may use a bipartite graph algorithm as depicted in the example of FIG. 2.

As illustrated in the example of FIG. 2, the request handler 108 may handle service requests by comparing a current state 202 with a projected state 210. The projected state 210 corresponds to a state if the service platform 104 were to satisfy a particular service request. Current service requests 204 may require changes (e.g., with respect to the resources 110, if any, allocated to each of the requests). Predicted service requests 206 are potential future service requests that may be considered “dynamic” or “pop-up” requests, in the sense that they don't exist yet but may arise at some indeterminate time in the future. The service platform 104 may be configured to use rules, statistical analysis, user input (e.g., by a subject matter expert), and/or machine learning techniques (for example, based on a history of service request handling) to model the predicted service requests 206.

As in FIG. 1, resources 110 represent the current resources over which the service platform 104 has control. Edges between nodes (i.e., between service requests and resources) exist where a resource 110 is capable (either individually or in combination with other resources 110) of satisfying the service request.

In an embodiment, the weight of each edge between a particular resource and a service request depends on one or more factors. For example, in the case of a predicted service request, the weight of an edge may depend on the expected likelihood of that particular service request arising. Alternatively or additionally, the weight of an edge may depend on the affinity for a resource 110 to satisfy the service request (i.e., how well-suited the resource is to satisfying the service request and/or the likelihood of success if the particular resource 110 is used to satisfy the service request), the amount of the resource 110 available, and/or one or more other factors or a combination thereof. In FIG. 2, different line thicknesses correspond to examples of edges having different weights. A factor that contributes to an edge weight may be computed using an offline estimate by a subject matter expert and/or historical data. Alternatively or additionally, a factor that contributes to an edge weight may be computed using machine learning techniques. For example, a machine learning model may be trained, using supervised learning, based on historical service handling data. The machine learning model may be updated, using unsupervised learning, as the service platform 104 operates over time.

In an embodiment, the density and connectivity in each of the graph states illustrated in FIG. 2 indicate, for that state, the service platform 104′s actual or projected capacity for satisfying new service requests. In the projected state 210, the resource(s) needed to satisfy the service request(s) in question are removed, essentially performing a “what-if” analysis to reassess the projected capacity of the service platform 104. In this particular example, resource R2 is removed to satisfy a service request that is not shown in the figures. The difference between the two states indicates the opportunity cost of satisfying the service request. In addition, the request handler 108 may account for the benefit that would be provided by satisfying the service request. The benefit may depend, for example, on features such as request priority (with higher-priority requests providing a greater benefit). The resulting benefit score may be incorporated into the opportunity cost metric(s), to produce a single weighted-sum value. For example, the following formula may be used:

opportunity_cost=weight1*(sum(weights of edges in current state graph)−sum(weights of edges in projected state graph))+weight2*(sum(f1(incoming edge count for service request in projected state graph))−sum(f1(incoming edge count for service request in current state graph)))

where f1(x) is an inverse exponential function (such as (0.5)^{x}) that gives a larger result for smaller values of x. Here, smaller values of x correspond to service request nodes that have a smaller number of incoming edges and accordingly fewer resource options available to satisfy those service requests.

The formula above is provided as an example only and should not be construed as limiting the scope of one or more embodiments. In this example, the opportunity cost of satisfying the service request is reflected in the resulting metric. “Weight1” and “weight2” are weights assigned to two different factors that contribute to the metric. These weights may be user-configurable (e.g., via a user interface 106 as described above). In some cases, the weights may be normalized so that they always add up to a particular value (e.g., one, or one hundred percent).

In an embodiment, the first factor in the opportunity cost metric is based on the sums of all the edge weights in each state. This sum corresponds to the system's overall capacity for satisfying service requests. A change in the sum indicates either an increase or decrease in capacity, depending on the direction of the change. Depending on the factors that contribute to the edge weights, the sum may also take into account the overall affinity of the available resources 110 to satisfy service requests.

In an embodiment, the second factor in the opportunity cost metric is based on the number of service requests with fewer incoming edges in the projected state. A reduction in incoming edges for a service request indicates that fewer (or no) resources will be available to satisfy that service request. The inverse power function gives a larger penalty for reducing the capacity for service requests that have fewer resource options available. Such penalties may thus help avoid scenarios where the service platform 104′s capability to satisfy service requests is dramatically reduced.

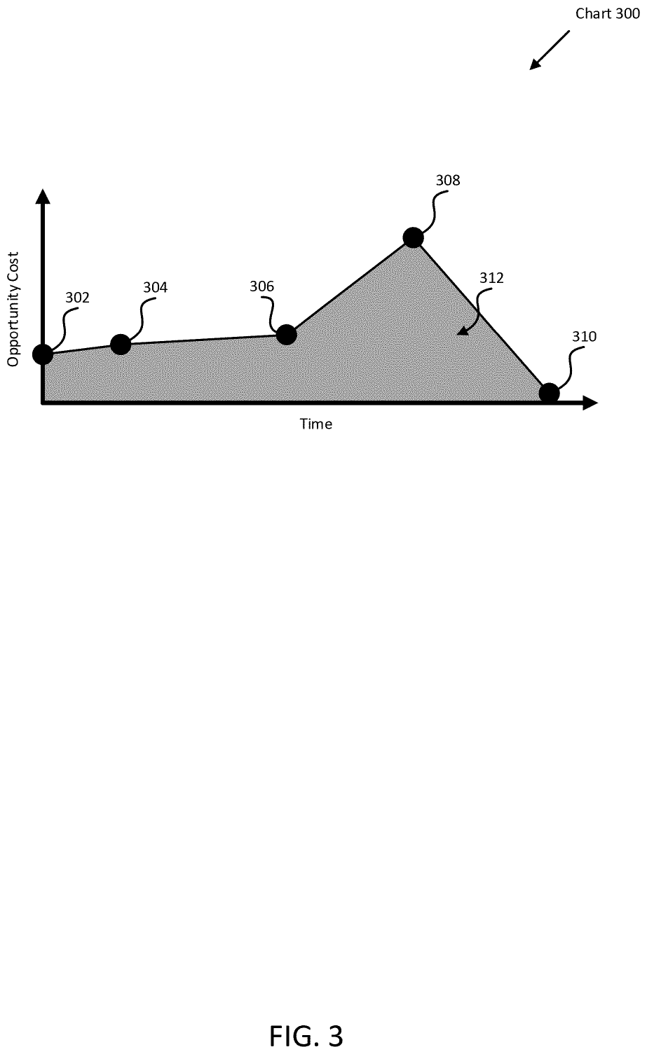

FIG. 3 illustrates an example of a chart 300 according to an embodiment. Specifically, the chart 300 indicates opportunity cost metrics 302, 304, 306, 308, 310 computed over time. The different values of opportunity cost metrics incorporate changes in resource availability over time. For example, the “bump” in opportunity cost from point 306 to point 308 may indicate that significant resources were allocated to service requests in the intervening time. The decrease in opportunity cost from point 308 to point 310 may indicate that service requests were completed and the resources allocated to those service requests became available again.

In addition to computing opportunity cost metrics for specific times, the service platform 104 may compute the area 312 under the curve of those values. The area 312 may correspond to an overall opportunity cost metric. The service platform 104 may be configured to compute and evaluate multiple metrics, such as specific point values, the overall area 312, the area for a particular time range, and/or another metric or combination thereof.

In an embodiment, the service platform 104 is configured to compare different options for satisfying service requests (e.g., different resources to allocate, different sequences in which to satisfy a given set of service requests, etc.). For each option, the service platform 104 may compute corresponding opportunity cost metrics and compare those metrics to determine which option (if any) to use. For example, the service platform 104 may compute and compare the areas under the curves for two or more different options.

As illustrated in the examples of FIGS. 2 and 3, an opportunity cost metric may have a temporal component, because resource allocations and commitments are bounded by a start time and an end time (either of which may be known or indeterminate). Over time, resources may be added back into the available pool and corresponding edges added back to the graph. The likelihood of a particular service request requiring a change may thus evolve over time, as service requests are started and completed. Accordingly, the service platform 104 may be configured to compute opportunity cost metrics (e.g., using a graph-based metric as described above) at discreet time intervals. For example, the service platform 104 may be configured to compute an opportunity cost metric when the state of the graph changes materially due to expiring resource commitments (e.g., as illustrated in FIGS. 2 and 3).

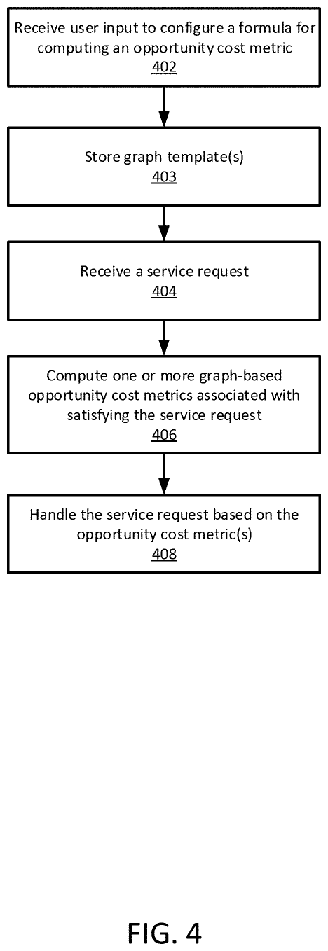

FIG. 4 is a flow diagram of an example of operations for graph-based handling of service requests according to an embodiment. One or more operations illustrated in FIG. 4 may be modified, rearranged, or omitted all together. Accordingly, the particular sequence of operations illustrated in FIG. 4 should not be construed as limiting the scope of one or more embodiments.

In an embodiment, a service platform (e.g., the service platform 104 of FIG. 1) receives user input to configure a formula for computing an opportunity cost metric (Operation 402). For example, the service platform may receive user input (e.g., from an administrator and/or subject matter expert) indicting one or more weights assigned to one or more factors that contribute to computation of an opportunity cost metric. A non-limiting example of a weighted function is provided above. Alternatively or additionally, one or more weights may be based on machine learning and/or obtained from another source.

In an embodiment, the service platform stores one or more graph templates (Operation 403). A graph template is a set of one or more criteria to be compared with a graph or set of graphs (e.g., a set including a current graph and a projected graph). A graph template may include descriptive text that indicates, in plain language, the actual and/or projected system state(s) represented by the one or more matching criteria.

As one example, a graph template may include one or more criteria that a service request node has at least one incoming edge in the current state graph (e.g., current state 202 of FIG. 2) and zero incoming edges in the projected state graph (e.g., projected state 210 of FIG. 2). An absence of incoming edges in the projected state graph would indicate that the service request represented by the node could no longer be satisfied, since the only resource(s) available to satisfy that service request would have been allocated elsewhere. Descriptive text associated with this example template may indicate, for example, that the resource allocation would have a higher opportunity cost than another resource allocation where the necessary resource(s) is/are still available for that service request. The example illustrated in FIG. 2 would not match this example graph template, since all the service request nodes still have incoming edges in the projected state graph.

As another example, a graph template may include one or more criteria that a service request node has more than one incoming edge in the current state graph and only one incoming edge in the projected state graph. Descriptive text associated with this example template may include a warning that the projected service request(s) can be handled, but with no spare capacity remaining to handle unanticipated service requests. The example illustrated in FIG. 2 would match this example template, since service request P2 has two incoming edges in the current state graph 202 and only one incoming edge in the projected state graph 210. In the projected state, resource R4 is the only resource capable of satisfying service request P2.

In an embodiment, graph templates include priority levels (e.g., numeric priorities, where a higher number corresponds to a higher or lower priority, depending on how the priority scale is defined). Alternatively or additionally, the service platform may store default descriptive text, to be used when no graph templates match the given state graph(s),In an embodiment, the service platform receives a service request (Operation 404). Some non-limiting examples of service requests are described herein. Specifically, the service request requires at least one resource, from a finite set of resources available to the service platform. Some non-limiting examples of finite resources are described herein.

In an embodiment, the service platform computes one or more graph-based opportunity cost metrics associated with satisfying the service request (Operation 406). If only one resource allocation is possible to satisfy the service request, the service platform may compute only a single graph-based opportunity cost metric. If multiple resource allocations are possible to satisfy the service request, the service platform may compute opportunity cost metrics associated with two or more possible resource allocations.

To compute an opportunity cost metric, the service platform may generate a “before” graph corresponding to a current state of available resources, and a projected “after” graph corresponding to a projected state of available resources after satisfying the service request. Some nodes in a graph may correspond to resources and other nodes may correspond to service requests, with edges connecting the two types of nodes. The projected state of available resources may include one or more resources that are predicted to become available in the amount of time needed to satisfy the service request (e.g., as resources are freed up after handling other service request).

For each graph, the service platform may apply a formula that sums the weights of the edges in that graph. An opportunity cost metric may be based, at least in part, on the difference between the sums for the “before” and “after” graphs. Alternatively or additionally, an opportunity cost metric may be based, at least in part, on an inverse exponential function applied to edge counts in the “before” and “after” graphs. The service platform may compute multiple opportunity cost values projected over a period of time and the opportunity cost metric may be based, at least in part, on an area under the curve of the multiple opportunity cost values.

In an embodiment, the service platform handles the service request based on the computed opportunity cost metric(s) (Operation 408). Some non-limiting examples of handling service requests are described herein. To handle the service request, the service platform may compare the opportunity cost metric with a threshold value. If the comparison indicates that the opportunity cost of satisfying the service request is too great, the service platform may decline to satisfy the service request. The service platform may refer a declined service request to another service platform. If the opportunity cost of satisfying the service request is acceptable, then the service platform may proceed to satisfy the service request.

Before satisfying the service request, the service platform may request user approval. For example, the service platform may present one or more service handling options (e.g., one or more resource allocation options) in a user interface, optionally with accompanying opportunity cost metrics for the user's consideration. The service platform may compare the state graph(s) with graph templates. If graph templates include priority levels, the service platform may perform the comparison in order of template priority, from highest to lowest. If the state graph(s) match one or more graph templates, the service platform may obtain descriptive text associated with the matching template(s), or a default descriptive text if no match is found. When presenting the option(s) to a user, the service platform may also present the descriptive text, to assist the user in decision-making. Alternatively or additionally, if resource allocation is automated, the service platform may store the descriptive text in a log, to facilitate human auditing of the decision-making process (i.e., to help a human auditor understand the reason(s) behind a given automated resource allocation decision). The service platform may receive user input indicating whether to proceed with satisfying the service request using an option that was presented. If multiple options were presented, the user input may indicate which option to use to satisfy the service request. The service platform may satisfy the service request responsive to receiving the user input.

Several examples are described below for purposes of clarity. Components and/or operations described below should be understood as examples that may not be applicable to one or more embodiments. Accordingly, components and/or operations described below should not be construed as limiting the scope of one or more embodiments.

In one example, a ride sharing service offers several kinds of ride sharing: single-customer, small-scale carpooling (e.g., up to 3 passengers), and large-scale carpooling (e.g., up to 6 passengers). The ride sharing service receives a request for a single-customer vehicle. The ride sharing service computes opportunity cost metrics for different handling options that include: allocating a single-customer vehicle as requested; allocating a seat in a small-scale carpooling vehicle; allocating a seat in a large-scale carpooling vehicle; and declining to satisfy the service request. Based on a comparison of the opportunity costs, the ride sharing service determines that allocating a single-customer vehicle would significantly impair the ability to satisfy a predicted high-priority request. Accordingly, the ride sharing service response to the service request with an offer of a seat in a small-scale or large-scale carpooling vehicle instead. Alternatively, the ride sharing service may adjust pricing for the single-customer vehicle, in order to decrease the opportunity cost associated with that option.

In another example, a service provider acts as a broker for multiple different ride-sharing services. The service provider may be configured to evaluate the opportunity cost for each ride-sharing service to satisfy a particular service request, and direct the service request to the ride- sharing service having the lowest opportunity cost.

In yet another example, operations described herein may be used to allocate resources to military operations. A subject matter expert or automated system may generate a set of tasks or “plays” to be executed as part of a military operation. A command system may transmit one or more service requests, corresponding to one or more of the tasks, to a service provider. The service provider is configured to determine which resources, if any, are available to satisfy the service request. The service provider may be configured to handle service requests based on the resources available in a single domain. Alternatively, the service provider may be configured to handle service requests based on orchestrated resources available in multiple domains (e.g., air, maritime, ground, etc., and/or multiple security domains configured to communicate via a cross-domain solution). For example, each domain may use an ontology to represent its available resources and communicate the available resources to the service provider. The service provider may be configured to compute opportunity cost metrics for different options, based on the available resources. For example, the service provider may determine that the opportunity cost associated with using maritime assets to satisfy the service request would be very high, while the opportunity cost associated with using air assets to satisfy the service request would be comparatively low. The service provider may also be configured to rank the options based on one or more ranking criteria (e.g., based on the corresponding opportunity cost metrics). The service provider communicates the results back to the command system, where a human operator or automated system selects from the available options to satisfy the service request. The service provider may thus allow for more efficient use of military resources, increasing the likelihood that limited resources will be available for future tasks.

In an embodiment, a system includes one or more devices, including one or more hardware processors, that are configured to perform any of the operations described herein and/or recited in any of the claims.

In an embodiment, one or more non-transitory computer-readable storage media store instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

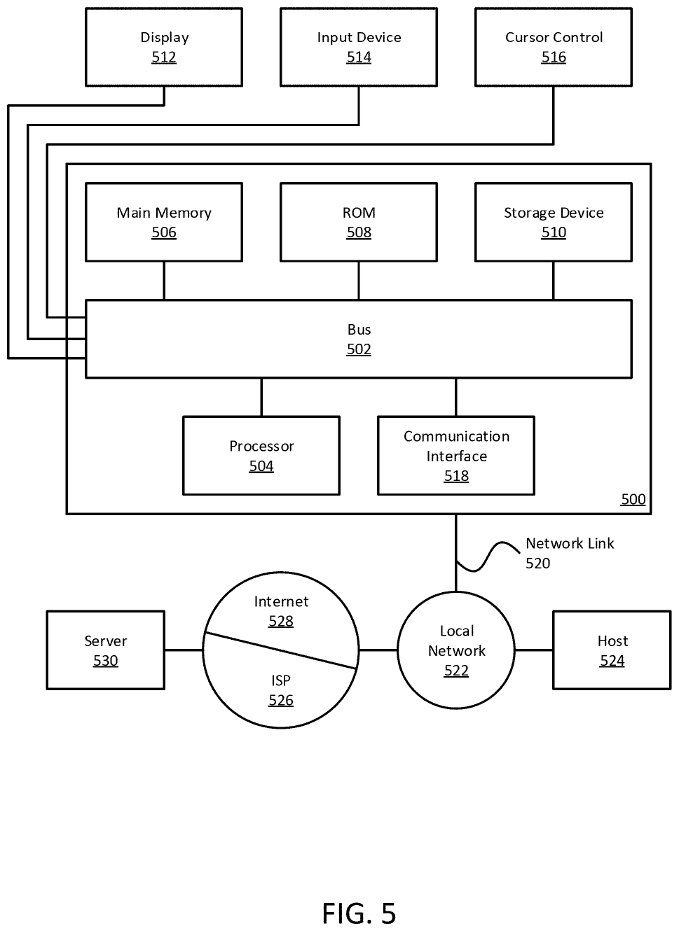

For example, FIG. 5 is a block diagram of an example of a computer system 500 according to an embodiment. Computer system 500 includes a bus 502 or other communication mechanism for communicating information, and a hardware processor 504 coupled with the bus 502 for processing information. Hardware processor 504 may be a general-purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in one or more non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), plasma display, electronic ink display, cathode ray tube (CRT) monitor, or any other kind of device for displaying information to a computer user. An input device 514, including alphanumeric and other keys, may be coupled to bus 502 for communicating information and command selections to processor 504. Alternatively or additionally, computer system 500 may receive user input via a cursor control 516, such as a mouse, a trackball, a trackpad, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Alternatively or additionally, computer system 4 may include a touchscreen. Display 512 may be configured to receive user input via one or more pressure-sensitive sensors, multi-touch sensors, and/or gesture sensors. Alternatively or additionally, computer system 500 may receive user input via a microphone, video camera, and/or some other kind of user input device (not shown).

Computer system 500 may implement the techniques described herein using customized hard-wired logic, one or more ASICs or FPGAs, firmware, and/or program logic which in combination with other components of computer system 500 causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that comprise bus 502. Transmission media may also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 500 may receive the data from the network and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522, and communication interface 518.

The received code may be executed by processor 504 as it is received, and/or stored in storage device 510, or other non-volatile storage for later execution.

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID's. Additionally or alternatively, data structures and/or datasets, stored by the computer network, are tagged with tenant ID's. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant ID's of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

What is claimed is:

1. One or more non-transitory computer-readable media storing instructions that, when executed by one or more processors, cause the one or more processors to perform operations comprising:
receiving a service request that requires at least one resource from a plurality of available resources;
computing a first graph-based opportunity cost metric associated with satisfying the service request; and
handling the service request based at least on the first graph-based opportunity cost metric.

2. The one or more non-transitory computer-readable media of claim 1, the operations further comprising:
computing a second graph-based opportunity cost metric associated with satisfying the service request,
wherein the first graph-based opportunity cost metric is based on a first resource allocation from among the plurality of available resources,
wherein the second graph-based opportunity cost metric is based on a second resource allocation from among the plurality of available resources, and
wherein handling the service request comprises satisfying the service request using one of the first resource allocation or the second resource allocation.

3. The one or more non-transitory computer-readable media of claim 1, the operations further comprising:
receiving user input indicating one or more weights assigned to one or more factors contributing to computation of the first graph-based opportunity cost metric.

4. The one or more non-transitory computer-readable media of claim 1, wherein computing the first graph-based opportunity cost metric associated with satisfying the service request comprises:
comparing a first graph corresponding to a current state of available resources before satisfying the service request with a second graph corresponding to a projected state of available resources after satisfying the service request,
wherein the second graph includes one or more resources predicted to become available in a time interval needed to satisfy the service request, and
wherein the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph.

5. The one or more non-transitory computer-readable media of claim 1, the operations further comprising:
comparing a current state graph and a projected state graph with one or more predefined graph templates,
wherein handling the service request comprises, responsive to determining that the current state graph and the projected state graph match a particular graph template in the one or more predefined graph templates, presenting descriptive text associated with the particular predefined graph template.

6. The one or more non-transitory computer-readable media of claim 1, wherein computing the first graph-based opportunity cost metric associated with satisfying the service request comprises:
computing a plurality of opportunity cost values over time; and
computing an area under a curve of the plurality of opportunity cost values.

7. The one or more non-transitory computer-readable media of claim 1,
wherein the first graph-based opportunity cost metric is based at least on weights of edges between a first set of nodes corresponding to the plurality of available resources and a second set of nodes corresponding to current service requests and predicted future service requests, and
wherein the weights of the edges are based, at least in part, on one or more of service request priorities and resource affinities for satisfying service requests.

8. A system comprising:
at least one device including a hardware processor;
the system being configured to perform operations comprising:
receiving a service request that requires at least one resource from a plurality of available resources;
computing a first graph-based opportunity cost metric associated with satisfying the service request; and
handling the service request based at least on the first graph-based opportunity cost metric.

9. The system of claim 8, the operations further comprising:
computing a second graph-based opportunity cost metric associated with satisfying the service request,
wherein the first graph-based opportunity cost metric is based on a first resource allocation from among the plurality of available resources,
wherein the second graph-based opportunity cost metric is based on a second resource allocation from among the plurality of available resources, and
wherein handling the service request comprises satisfying the service request using one of the first resource allocation or the second resource allocation.

10. The system of claim 8, the operations further comprising:
receiving user input indicating one or more weights assigned to one or more factors contributing to computation of the first graph-based opportunity cost metric.

11. The system of claim 8, wherein computing the first graph-based opportunity cost metric associated with satisfying the service request comprises:
comparing a first graph corresponding to a current state of available resources before satisfying the service request with a second graph corresponding to a projected state of available resources after satisfying the service request,
wherein the second graph includes one or more resources predicted to become available in a time interval needed to satisfy the service request, and
wherein the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph.

12. The system of claim 8, wherein computing the first graph-based opportunity cost metric associated with satisfying the service request comprises:
computing a plurality of opportunity cost values over time; and
computing an area under a curve of the plurality of opportunity cost values.

13. The system of claim 8,
wherein the first graph-based opportunity cost metric is based at least on weights of edges between a first set of nodes corresponding to the plurality of available resources and a second set of nodes corresponding to current service requests and predicted future service requests, and
wherein the weights of the edges are based, at least in part, on one or more of service request priorities and resource affinities for satisfying service requests.

14. A method comprising:
receiving a service request that requires at least one resource from a plurality of available resources;
computing a first graph-based opportunity cost metric associated with satisfying the service request; and
handling the service request based at least on the first graph-based opportunity cost metric.

15. The method of claim 14, further comprising:
computing a second graph-based opportunity cost metric associated with satisfying the service request,
wherein the first graph-based opportunity cost metric is based on a first resource allocation from among the plurality of available resources,
wherein the second graph-based opportunity cost metric is based on a second resource allocation from among the plurality of available resources, and
wherein handling the service request comprises satisfying the service request using one of the first resource allocation or the second resource allocation.

16. The method of claim 14, further comprising:
receiving user input indicating one or more weights assigned to one or more factors contributing to computation of the first graph-based opportunity cost metric.

17. The method of claim 14, wherein computing the first graph-based opportunity cost metric associated with satisfying the service request comprises:
comparing a first graph corresponding to a current state of available resources before satisfying the service request with a second graph corresponding to a projected state of available resources after satisfying the service request,
wherein the first graph-based opportunity cost metric is based, at least in part, on one or more of (a) a difference between a first sum of edge weights in the first graph and a second sum of edge weights in the second graph and (b) an inverse exponential function applied to a first incoming edge count in the first graph and a second incoming edge count in the second graph.

18. The method of claim 17, wherein the second graph includes one or more resources predicted to become available in a time interval needed to satisfy the service request.

19. The method of claim 14, wherein computing the first graph-based opportunity cost metric associated with satisfying the service request comprises:
computing a plurality of opportunity cost values over time; and
computing an area under a curve of the plurality of opportunity cost values.

20. The method of claim 14,
wherein the first graph-based opportunity cost metric is based at least on weights of edges between a first set of nodes corresponding to the plurality of available resources and a second set of nodes corresponding to current service requests and predicted future service requests, and
wherein the weights of the edges are based, at least in part, on one or more of service request priorities and resource affinities for satisfying service requests.
